(19) United States
(12) Patent Application Publication
(10) Pub. No.: US 2024/0217592 A1
(43) Pub. Date: Jul. 4, 2024

(54) Short Offset Deck Bedslide Assembly

(71) Applicant: Leer Group, Elkhart, IN (US)

(72) Inventors: Eugene A. Dylewski, II, Granger, IN (US); Harley D. Harrison, South Bend, IN (US)

(21) Appl. No.: 18/392,974

(22) Filed: Dec. 21, 2023

Related U.S. Application Data
(60) Provisional application No. 63/435,950, filed on Dec. 29, 2022.

(51) Int. Cl. B62D 33/02

(52) U.S. Cl. CPC B62D 33/0207

(57) ABSTRACT

A bedslide assembly is provided that includes a bottom frame, a top frame, and a deck. The bottom frame includes at least one rail. The top frame includes at least one rail. The deck attached to the top frame. The at least one rail of the bottom frame engages the at least one rail of the top frame. The at least one rail of the top frame is slidable along the at least one rail of the bottom frame. The at least one rail of the top frame is extendable from the at least one rail of the bottom frame. The at least one rail of the bottom frame is longer than the at least one rail of the top frame.

### RELATED APPLICATIONS

The present application relates to and claims priority to U.S. Provisional Patent Application, Ser. No. 63/435,950, filed on Dec. 29, 2022. The subject matter disclosed in that Provisional Application is hereby expressly incorporated into the present application.

### TECHNICAL FIELD AND SUMMARY

The present disclosure relates to trucks such as pickup trucks and like vehicles with truck beds or cargo boxes installed thereon. In particular, the present disclosure relates to differently-sized and configured bedslide assemblies affixed to the truck beds or cargo boxes.

A truck bed or cargo box is a large open space of a pickup truck located behind the truck's cab section. The cargo box is typically composed of a floor bounded by opposing sidewalls. A bulkhead extends between the opposed sidewalls adjacent the cab section. A tailgate is located opposite the bulkhead at the rear end of the cargo box and is movable between open and closed positions.

A bedslide assembly is a device that is attached to the cargo box and is extendable and retractable relative to the cargo box floor. For example, the bedslide may be slid over the cargo box floor and contained within the truck bed. Conversely, the bedslide may be pulled from the cargo box, not unlike a drawer pulled from a cabinet from the cargo box floor.

An issue with a bedslide assembly is that its deck typically covers as much of the cargo box floor between the wheel wells as possible. This makes sense since it maximizes the movable deck space over the floor.

An illustrative embodiment of the present disclosure, however, addresses an issue where other articles or accessories are needed to be stowed in the cargo box, but are not needed to be placed on a bedslide deck. Toolboxes, hose reels, and other accessories or structures need not be placed on a bedslide, but may need to occupy portions of real estate on the cargo box floor. Accordingly, the bedslides of the present disclosure occupy less than the entire floor space between the wheel wells to accommodate this real estate. These bedslides can, nonetheless, still operate and provide utility despite occupying less floor space in the cargo box.

An illustrative embodiment of the present disclosure, therefore, provides a bedslide assembly that includes a bottom frame, a top frame, and a deck. The bottom frame includes at least one rail. The top frame includes at least one rail. The deck is attached to the top frame. The at least one rail of the bottom frame engages the at least one rail of the top frame. The at least one rail of the top frame is slidable along the at least one rail of the bottom frame. The at least one rail of the top frame is extendable from the at least one rail of the bottom frame. The at least one rail of the bottom frame is longer than the at least one rail of the top frame. The at least one rail of the top frame does not retract to a rear portion of the bottom frame. The top frame and the deck extend outward from the bottom frame, but do not retract over an entirety of the bottom frame. The deck is positioned offset from the top frame such that a first side of the deck is positioned further from a first side of the top frame than a second side of the deck is positioned from a second side of the top frame.

In the above and other embodiments, the bedslide assembly may further comprise: a portion of the at least one rail of the bottom frame being exposed from the deck when the deck and the top frame are fully retracted; a static deck that is attachable to the rear portion of the bottom frame; a second deck located on the bedslide assembly, wherein the deck and the top frame are movable with respect to the bottom frame and the second deck; the second deck being movable with respect to the deck; the deck and the top frame are movable with respect to the bottom frame and the static deck; and the deck being selectively removable and replaceable with a plurality of different sized decks attachable to the top frame.

Another illustrative embodiment of the present disclosure provides a bedslide assembly that includes a bottom frame, a top frame, and a deck. The bottom frame includes at least one rail. The top frame includes at least one rail. The deck is attached to the top frame. The at least one rail of the bottom frame engages the at least one rail of the top frame. The at least one rail of the top frame is slidable along the at least one rail of the bottom frame. The at least one rail of the top frame is extendable from the at least one rail of the bottom frame. The at least one rail of the bottom frame is longer than the at least one rail of the top frame. The at least one rail of the top frame does not retract to a rear portion of the bottom frame. The top frame and the deck extend outward from the bottom frame, but do not retract over an entirety of the bottom frame.

In the above and other embodiments, the bedslide assembly may further comprise: the deck being positioned offset from the top frame such that a first side of the deck is positioned further from a first side of the top frame than a second side of the deck is positioned from a second side of the top frame; a portion of the at least one rail of the bottom frame is exposed from the deck when the deck and the top frame are fully retracted; a static deck that is attachable to the rear portion of the bottom frame; a second deck located on the bedslide assembly, wherein the deck and the top frame are movable with respect to the bottom frame and the second deck; the second deck being movable with respect to the deck; the deck and the top frame are movable with respect to the bottom frame and the static deck; and the deck being selectively removable and replaceable with a plurality of different sized decks attachable to the top frame.

Another illustrative embodiment of the present disclosure also provides a bedslide assembly that includes a bottom frame, a top frame, and a deck. The bottom frame includes at least one rail. The top frame includes at least one rail. The deck is attached to the top frame. The at least one rail of the bottom frame engages the at least one rail of the top frame. The at least one rail of the top frame is slidable along the at least one rail of the bottom frame. The at least one rail of the top frame is extendable from the at least one rail of the bottom frame. The at least one rail of the bottom frame is longer than the at least one rail of the top frame.

In the above and other embodiments, the bedslide assembly may further comprise: the at least one rail of the top frame does not retract to a rear portion of the bottom frame; the top frame and the deck extend outward from the bottom frame, but do not retract over an entirety of the bottom frame; and the deck being positioned offset from the top frame such that a first side of the deck is positioned further from a first side of the top frame than a second side of the deck is positioned from a second side of the top frame.

Additional features and advantages of the offset deck bedslide assembly will become apparent to those skilled in the art upon consideration of the following detailed descriptions of carrying out the offset deck bedslide assembly as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a cargo box with a portion of a sidewall and tailgate end removed;

FIG. 2 is another perspective view of the cargo box with a portion of the sidewall and tailgate end removed;

FIG. 3 is a top view of the cargo box with a tank, hose reel, and short offset bedslide assembly installed in the cargo box;

FIG. 4 is another perspective view of the cargo box with a portion of the sidewall and tailgate end removed;

FIG. 5 is a top view of the cargo box with the short offset bedslide assembly located therein;

FIG. 6 is another top view of the cargo box with the short offset bedslide assembly located therein

FIG. 7 is an isolated top view of the short offset bedslide assembly;

FIG. 8 is a side elevational view of the short offset bedslide assembly;

FIG. 9 is an isolated underside view of the short offset bedslide assembly;

FIG. 10 is another isolated underside view of the short offset bedslide assembly;

FIG. 11 is an isolated perspective underside view of the short offset bedslide assembly;

FIG. 12 is another isolated perspective underside view of the short offset bedslide assembly;

FIG. 13 is another isolated perspective underside view of the short offset bedslide assembly;

FIG. 14 is another isolated perspective underside view of the short offset bedslide assembly;

FIG. 15 is an isolated exploded perspective underside view of the short offset bedslide assembly;

FIG. 16 is a perspective view of the cargo box with a portion of the sidewall and tailgate end removed;

FIG. 17 is another perspective view of the cargo box with a portion of the sidewall and tailgate end removed;

FIG. 18 is another perspective view of the cargo box with a portion of the sidewall and tailgate end removed;

FIG. 19 is a top view of the cargo box with the short bedslide assembly located thereon;

FIG. 20 is another top view of the cargo box with the short bedslide assembly located thereon;

FIG. 21 is another top view of the cargo box with the short bedslide assembly located thereon;

FIG. 22 is an isolated top view of the short bedslide assembly;

FIG. 23 is an isolated side elevational view of the short bedslide assembly;

FIG. 24 is a perspective view of the cargo box with a portion of the sidewall and tailgate end removed;

FIG. 25 is another perspective view of the cargo box with a portion of the sidewall and tailgate end removed;

FIG. 26 is a top view of the cargo box with the short offset bedslide assembly located therein;

FIG. 27 is another top view of the cargo box with the short offset bedslide assembly located therein;

FIG. 28 is an isolated top view of the short bedslide assembly;

FIG. 29 is an isolated side elevational view of the short bedslide assembly;

FIG. 30 is an isolated perspective view of the short bedslide assembly;

FIG. 31 is another isolated perspective view of the short bedslide assembly;

FIG. 32 is an isolated underside view of the short bedslide assembly;

FIG. 33 is another isolated underside view of the short bedslide assembly;

FIG. 34 is an isolated underside perspective view of the short bedslide assembly;

FIG. 35 is another isolated underside perspective view of the short bedslide assembly;

FIG. 36 is another isolated underside perspective view of the short bedslide assembly;

FIG. 37 is another isolated underside perspective view of the short bedslide assembly; and

FIG. 38 is another isolated underside perspective view of the short bedslide assembly.

Corresponding reference characters indicate corresponding parts throughout the several views. The exemplification set out herein illustrates embodiments of the offset deck bedslide assembly, and such exemplification is not to be construed as limiting the scope of the offset deck bedslide assembly in any manner.

### DISCLOSURE OF ILLUSTRATIVE EMBODIMENTS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a bedslide having a deck that only occupies a portion of the real estate on the cargo box floor. In one embodiment, the bedslide deck is offset so that it does not occupy an entire lateral distance (e.g., from wheel well to wheel well) of the cargo box floor. In another embodiment, the bedslide deck does not occupy the cargo box floor from tailgate to bulkhead.

Illustratively, the bedslide deck is coupled to an upper frame assembly that moves along a standard-sized bedslide lower frame assembly. In another embodiment, any one of the bedslide decks disclosed herein may be removed and replaced with a full-sized bedslide deck that occupies much of the floor space from wheel well to wheel well and bulkhead to tailgate. In a further embodiment, a platform or fixed deck may be included that occupies a portion of the cargo box floor that the bedslide deck does not. In a further embodiment, the platform or fixed deck itself may be stationary with respect to the lower bedslide frame assembly. In a further embodiment, the lower frame is configured to attach to existing cargo box anchor points. In this way, different configurations of the bedslide deck and/or platform may be coupled to the standard lower frame assembly to create a modular bedslide system where differently-sized decks can utilize the same lower frame, as optional configurations for a user. The upper frame, bedslide, and deck may be shortened and/or narrowed to accommodate accessories required to be stowed in the cargo box, but not on the bedslide.

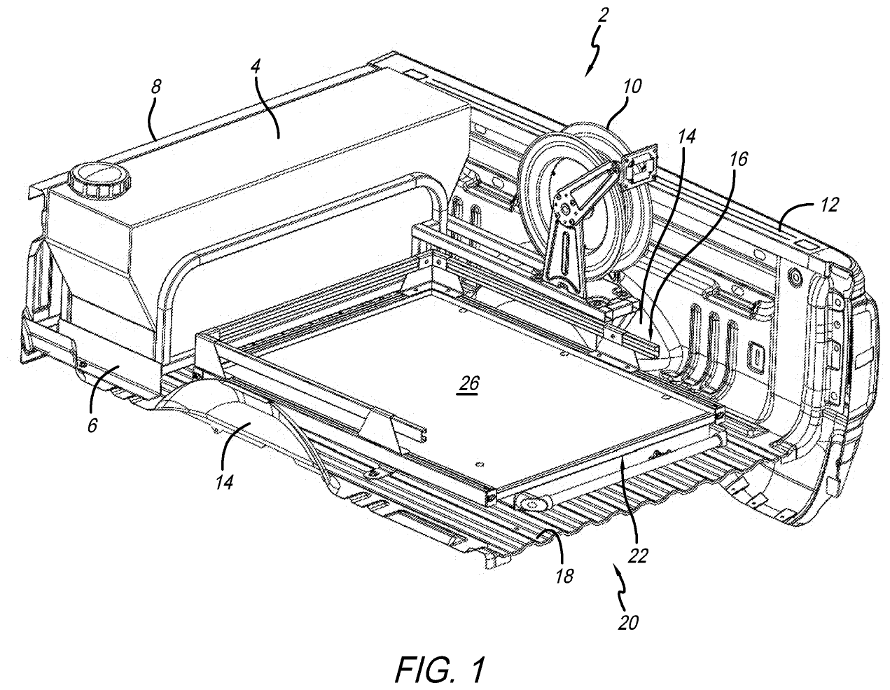

A perspective view of a cargo box 2, with a portion of a sidewall and tailgate end removed to better view the interior of cargo box 2, is shown in FIG. 1. Illustratively shown is a fluid tank 4 seated on a fluid tank support frame 6 adjacent bulkhead 8 of cargo box 2. Additionally, and illustratively, a hose reel 10 is located adjacent a sidewall 12 and wheel well 14 portion of sidewall 12 in cargo box 2. It is appreciated that such tanks 4, hose reels 10, and other accessories may necessarily be stowed in cargo box 2 while at the same time needing a bedslide assembly to stow and access additional accessories placed thereon. Also shown in this view is a short offset bedslide assembly 16 that is movable with respect to cargo box floor 18 and extendable from tailgate end 20 of same.

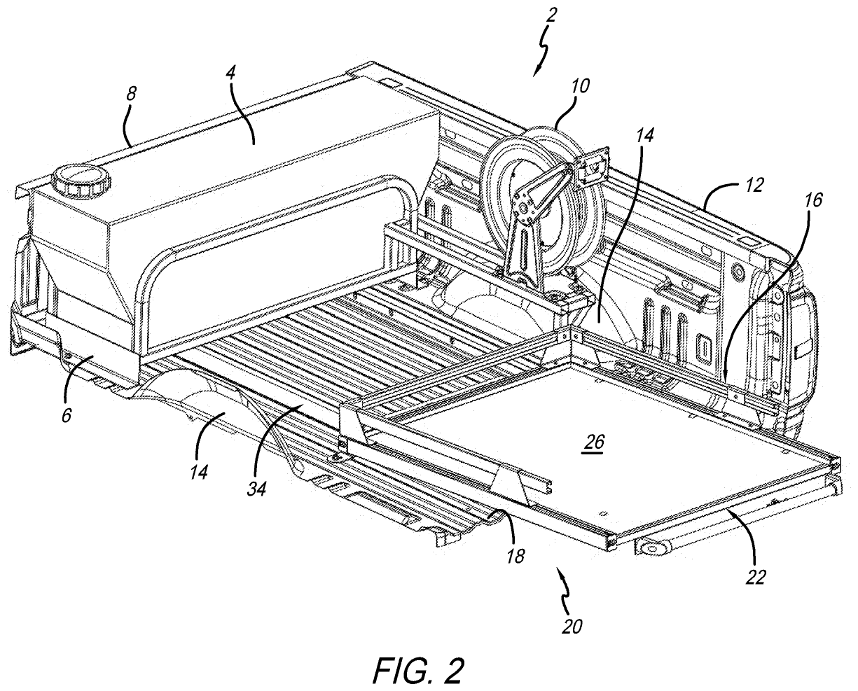

A perspective view of cargo box 2, of FIG. 1, is shown in FIG. 2, including fluid tank 4 seated on fluid tank support frame 6 and hose reel 10. This view differs from that of FIG. 1 in that, here, short offset bedslide 22 of short offset bedslide assembly 16 is extended from tailgate end 20 of cargo box 2. This view demonstrates how, despite requirements of stationary structures affixed to cargo box 2, a bedslide assembly can accommodate those structures while at the same time be operable to move to and from cargo box 2.

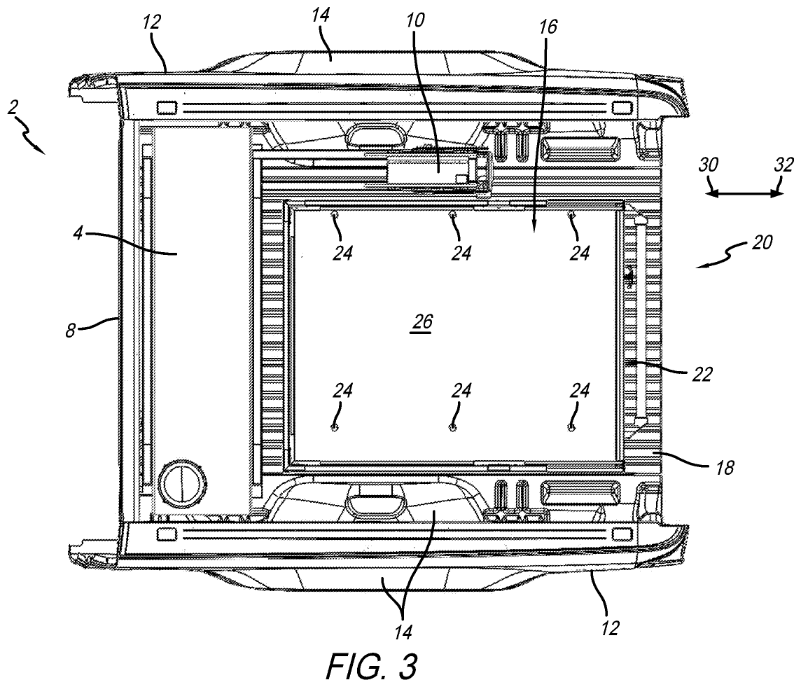

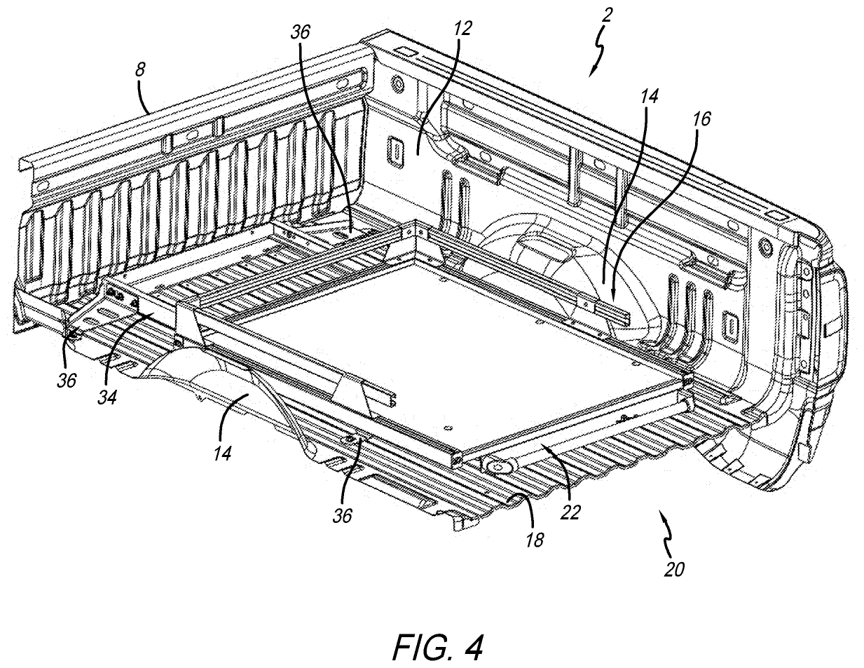

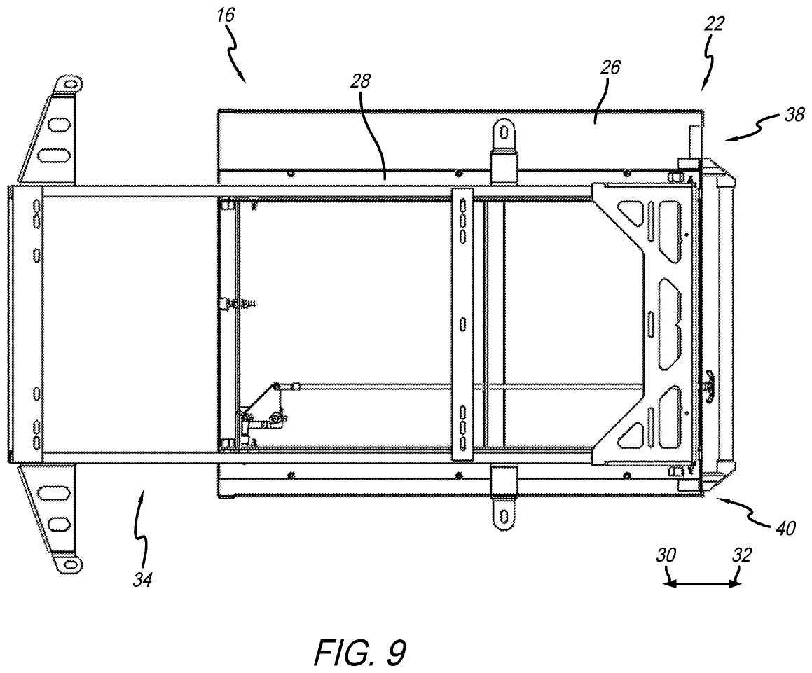

A top view of cargo box 2, with tank 4, hose reel 10, and short offset bedslide assembly 16 installed in cargo box 2, is shown in FIG. 3. Fasteners 24 are shown in this view extending through deck 26 of short offset bedslide 22 to attach to upper frame 28 (see, also, FIGS. 9-15). This allows offset bedslide 22 to move relative to cargo box floor 18 of cargo box 2, in directions 30 and 32, while accommodating, illustratively, hose reel 10 and fluid tank 4. As the positioning of fasteners 24 indicates, and as further shown in FIGS. 9-15, short offset bedslide 22 is cantilevered over one side of the upper and lower frames 28 and 34, respectively, more so than on the other side. It is appreciated that lower frame 34 may be a conventionally sized and configured bedslide frame that attaches to cargo box floor 18 (and, in some embodiments, other attachment points), as shown further in FIGS. 4-6. Lower frame 34 may be sized and configured to accommodate a conventional bedslide assembly, short bedslides, offset bedslides, or short offset bedslides, like that shown herein.

Another perspective view of cargo box 2, like that of FIGS. 1 and 2, is shown in FIG. 4. Here, fluid tank 4, fluid tank support frame 6, and hose reel assembly 10 have been removed from cargo box 2, leaving only short offset bedslide assembly 16. Lower frame 34 is shown centrally attached to cargo box floor 18 at conventional attachment points 36. The centrally positioned lower frame 34 is the location that would be normal for a conventionally sized bedslide. Short offset bedslide 22, shown in this view, is configured to allow for space to exist between it and wheel wells 14, as well as bulkhead 8. Again, upper and lower frames 28 and 34, respectively, shown in FIGS. 9-15, accommodate bedslide 22 and deck 26 to be cantilevered over one side of lower frame 34 to occupy as much space as possible, adjacent one wheel well 14, as shown, while being spaced apart from the opposing wheel well 14 and sidewall 12, such as where the illustrative hose reel assembly 10 is located, for example. Additionally, short offset bedslide 22 can only be slid on lower frame 34 to the extent shown. This ensures space remains between the end of short offset bedslide 22 (particularly deck 26), and bulkhead 8 to accommodate fluid tank 4 or other structures in cargo box 2.

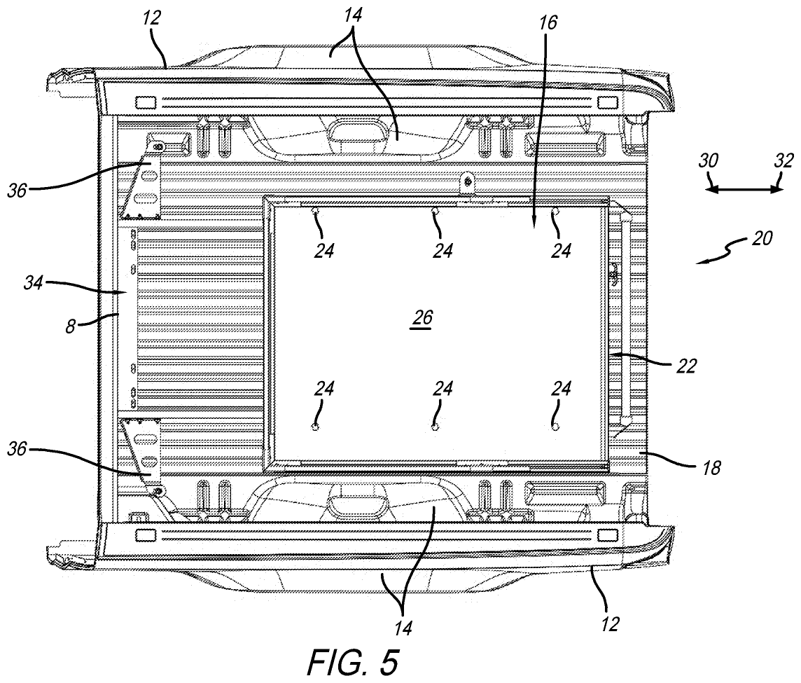

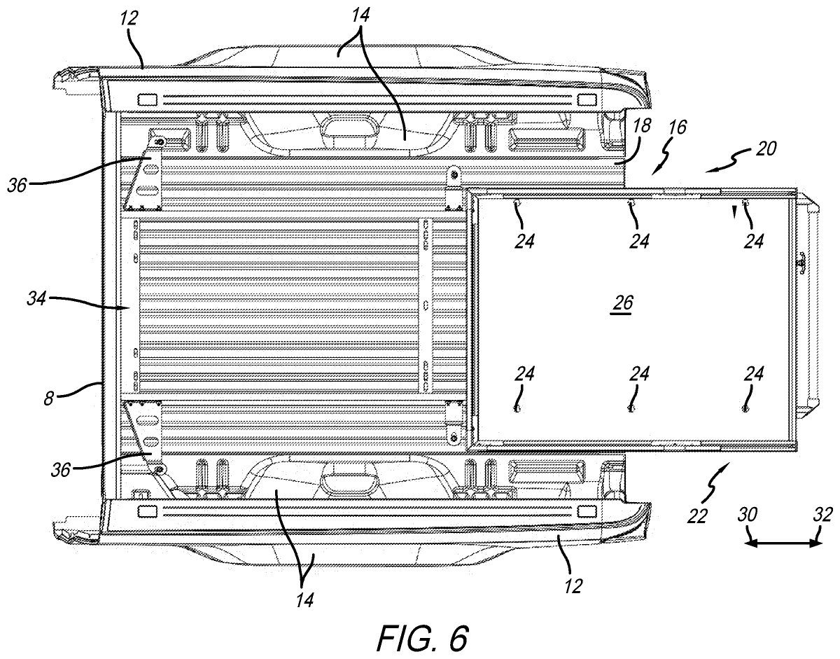

Top views of cargo box 2, with short offset bedslide assembly 16 located therein, from FIG. 4, are also depicted in FIGS. 5 and 6. The view in FIG. 5 shows short offset bedslide 22 retracted to its stowed position over standard lower frame 34. The view in FIG. 6, in contrast, shows short offset bedslide 22 extended in direction 32 from cargo box 2.

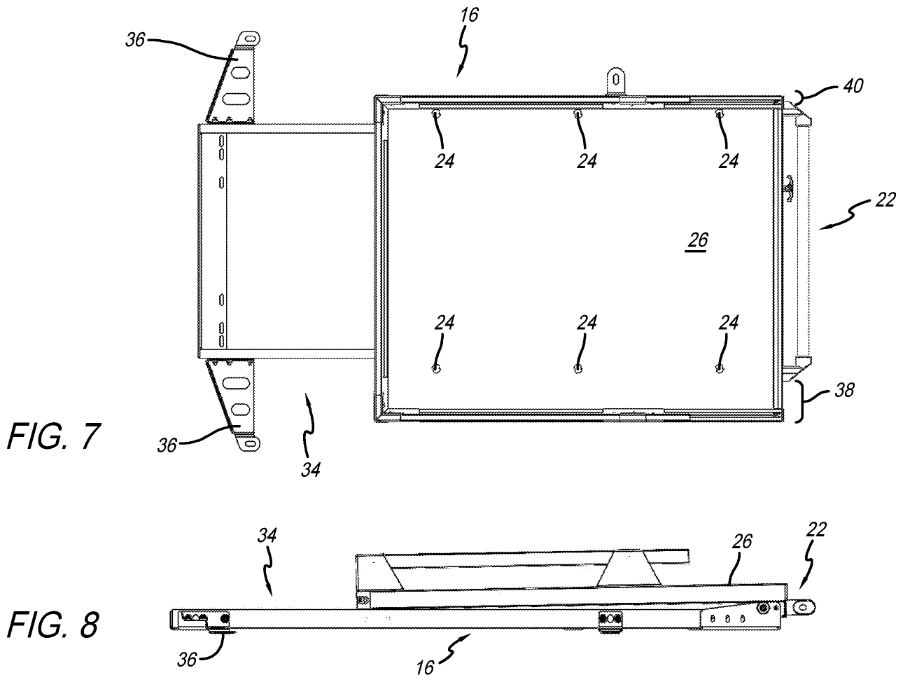

An isolated top view of short offset bedslide assembly 16 is shown in FIG. 7. This view further demonstrates how short offset bedslide 22 and deck 26 are not aligned with the center of lower frame 34. As the fasteners extending through the deck indicate, a portion of the left side (looking from tailgate end 20 to bulkhead 8) is cantilevered further (as indicted by reference number 38) from lower frame 34 than the right side of short offset bedslide 22 and deck 26 (see, also, FIGS. 9-15).

As shown in the side elevational view of short offset bedslide assembly 16 in FIG. 8, it is appreciated that short offset bedslide 22 does not extend all the way back over lower frame 34. As depicted in FIGS. 1 and 2, for example, fluid tank 4 or other accessory may be placed adjacent bulkhead 8 and set over the rear portion of the lower frame 34. This allows lower frame 34 to serve its purpose of providing a track or rail for bedslide 22 so long as bedslide 22 is configured not to interfere with fluid tank 4 or other accessory.

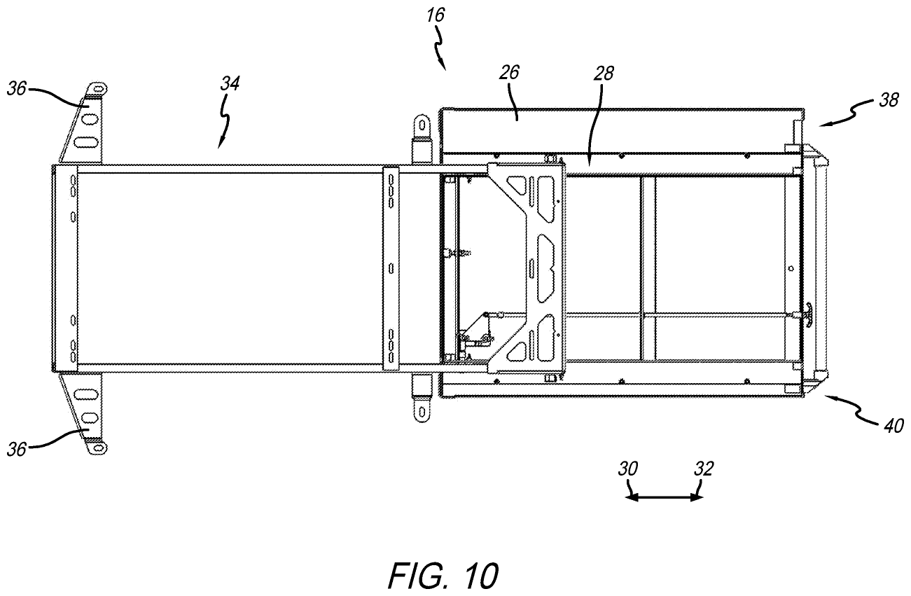

Isolated underside views of short offset bedslide assembly 16 are shown in FIGS. 9 and 10. The difference between the views of FIGS. 9 and 10 is that, in FIG. 9, short offset bedslide 22 is retracted in direction 30 fully onto lower frame 34, whereas in FIG. 10, short offset bedslide 22 is extended in direction 32 from a portion of lower frame 34. These views both show the relative positioning of short offset bedslide 22 relative to upper frame 28. As depicted, short offset bedslide 22 is cantilevered over one side, as indicated by reference number 38, of upper frame 28 more so than the other side. Because lower frame 34 is positioned centrally on cargo box floor 18 of cargo box 2, the lack of cantilevered deck of short offset bedslide 22 (as indicated by reference number 40) allows additional cargo box floor space adjacent one of the sidewalls 12 for hose reel 10 or other accessory (see, also, FIG. 1). It is appreciated that deck 26 of short offset bedslide 22 can be cantilevered opposite that shown in these figures to accommodate space on cargo box floor 18 of cargo box 2 adjacent the opposed sidewall.

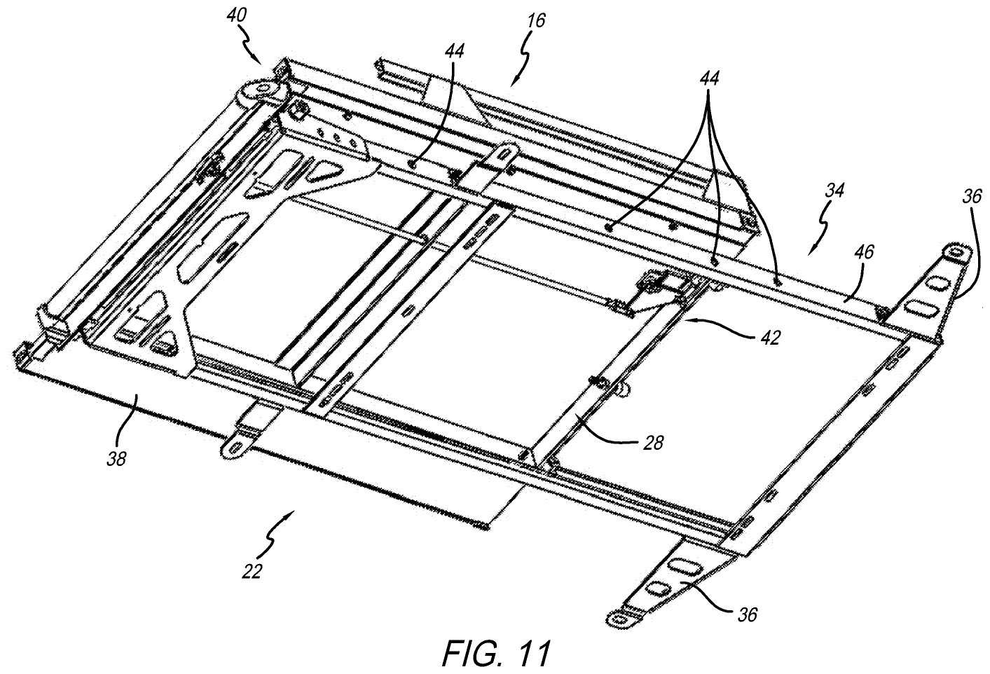

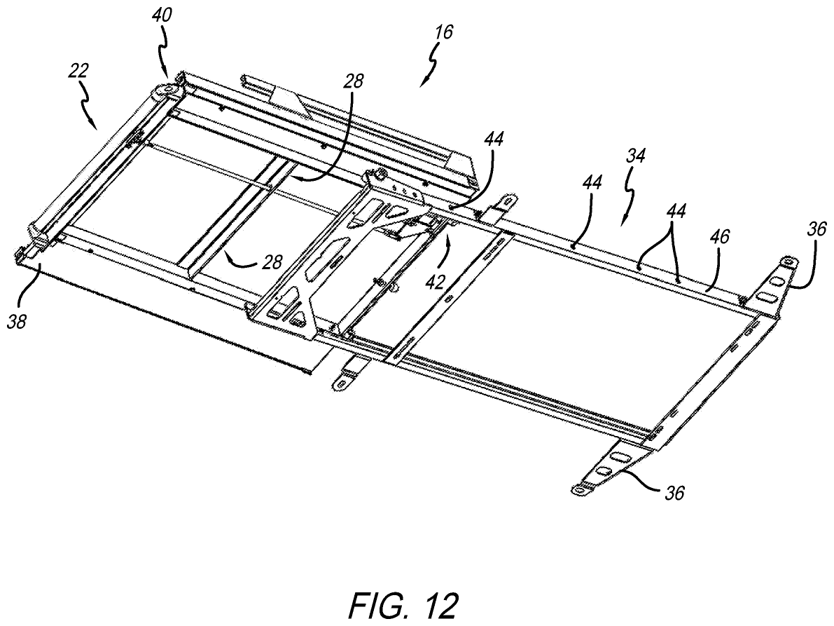

Isolated perspective underside views of short offset bedslide assembly 16 is shown in FIGS. 11 and 12. These views are similar to those of FIGS. 9 and 10 from the point of view that, in FIG. 11, short offset bedslide 22 is retracted onto lower frame 34 similar to that shown in FIG. 9. In FIG. 12, short offset bedslide 22 is extended from a portion of lower frame 34 similar to that of FIG. 10. These views demonstrate how the release mechanism 42 is shown engageable with the plurality of stop openings 44 disposed through a rail 46 of lower frame 34. These views also distinguish between cantilevered side 38 of the short offset bedslide 22 with respect to upper and lower frames 28 and 34, respectively, and non-cantilevered side 40. Again, it is appreciated, however, that deck 26 of short offset bedslide 22 may be configured so depicted non-cantilevered 40 side becomes cantilevered side 38 and vice versa for the other side.

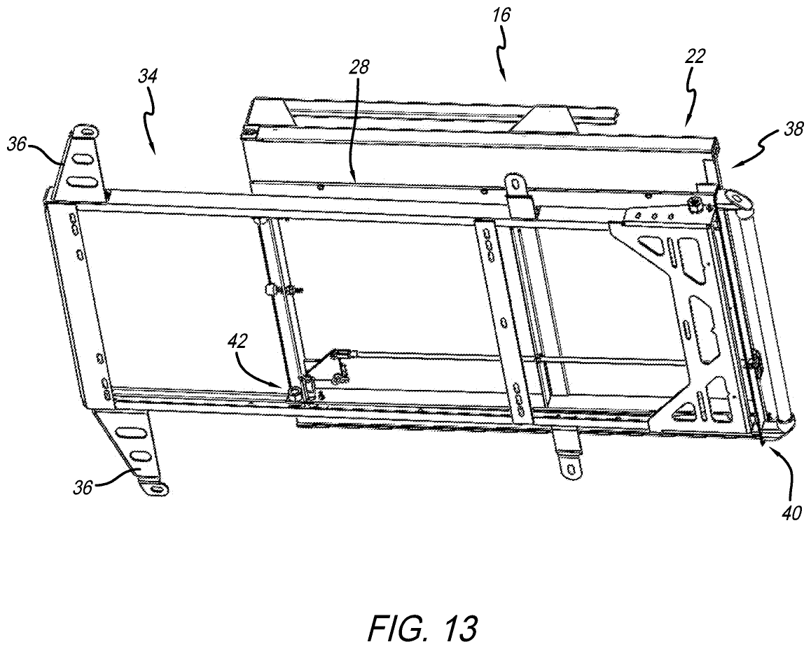

Another isolated underside perspective view of short offset bedslide assembly 16 is shown in FIG. 13. This view, again, depicts the relative positioning of short offset bedslide 22 on upper frame 28, which itself is movably coupled to lower frame 34. This view further depicts the short offset bedslide 22, with its upper frame 28 positioned in the retracted position with respect to lower frame 34.

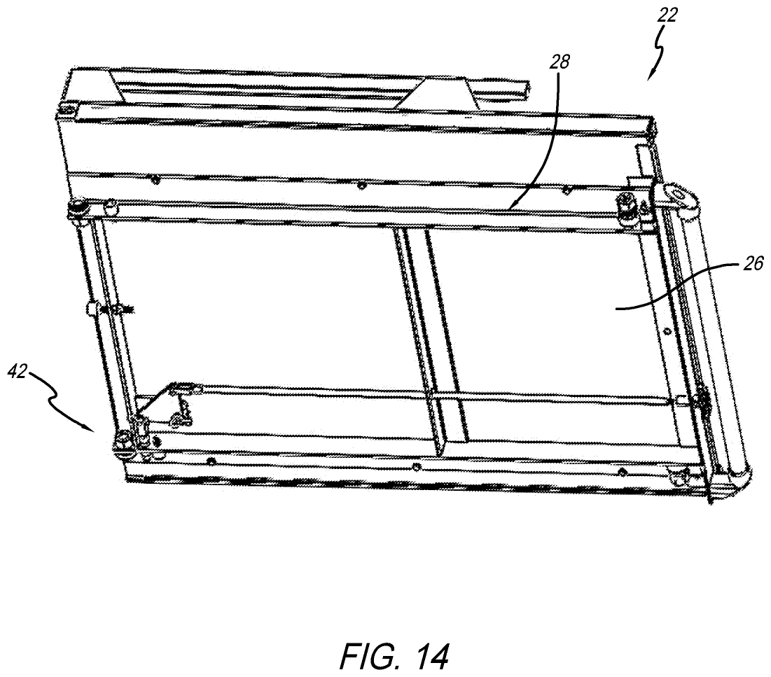

An isolated underside perspective view of short offset bedslide 22 and deck 26 are shown in FIG. 14. Along with deck 26, short offset bedslide 22 includes upper frame 28 that is illustratively offset to one side of deck 26 to allow for exposed floor space on this side of the cargo box 2 adjacent sidewall 12.

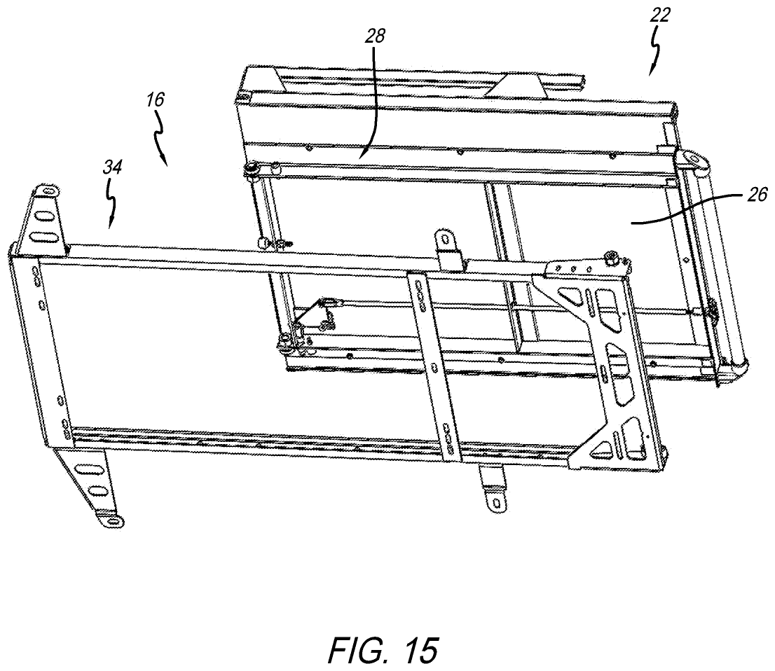

An isolated exploded underside perspective view of short offset bedslide assembly 16 is shown in FIG. 15. Here, short offset bedslide 22 is separated from lower frame 34 for illustrative purposes.

Another illustrative embodiment of the present disclosure provides a short deck bedslide assembly 52. Like the short offset bedslide assembly 16, the short bedslide assembly accommodates a fluid tank 4, toolbox, or other accessory to be located adjacent bulkhead 8 of cargo box 2. Additionally, the lower frame that is employed is the same as for a conventionally sized bedslide that would normally cover the lower frame when retracted. The lower frame may also be centrally located on cargo box floor 18 to accommodate a conventionally sized bedslide and deck. Here, however, short bedslide 54 and deck 56 fit between wheel wells 14 on cargo box floor 18 of cargo box 2 to maximize the usable width of same while not extending as far into the cargo box as a conventional bedslide and deck.

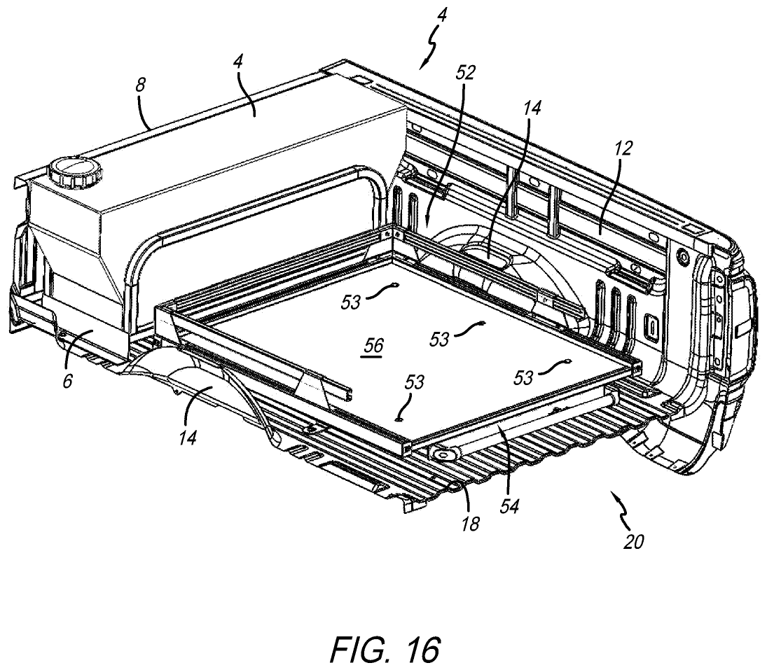

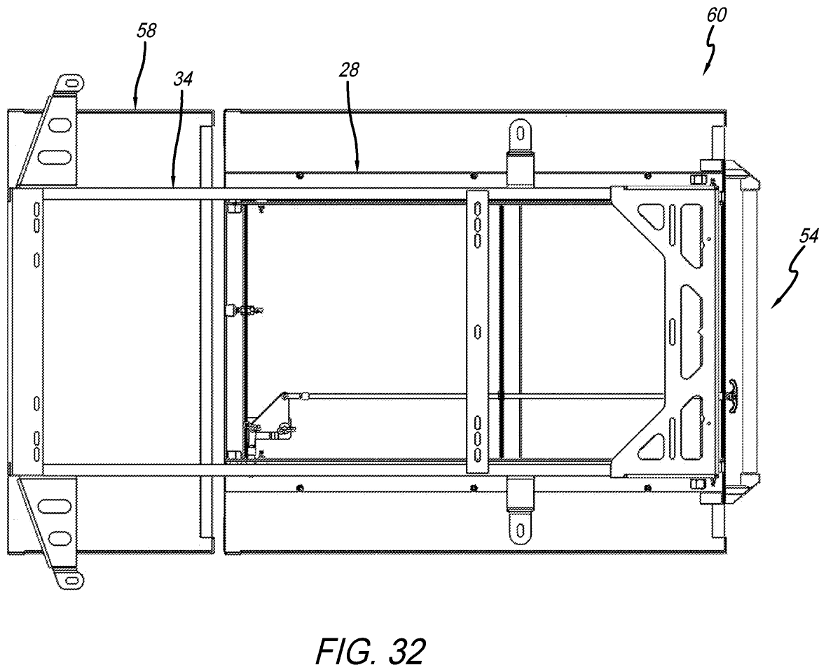

A perspective view of cargo box 2, with short bedslide assembly 52 contained therein, is shown in FIG. 16. Similar to the view in FIG. 1, as depicted, cargo box 2 includes fluid tank 4 located adjacent bulkhead 8. A distinction, however, is that there is no hose reel 10 located adjacent sidewall 12 and wheel well 14. Short bedslide assembly 52 is centrally located to appreciably cover cargo box floor 18 from wheel well 14 to wheel well 14. Fasteners 53 secure deck 56 to upper frame 28 (see, FIG. 32). Short bedslide 54 and deck 56 do not extend further into cargo box 2 similar to short offset bedslide assembly 16.

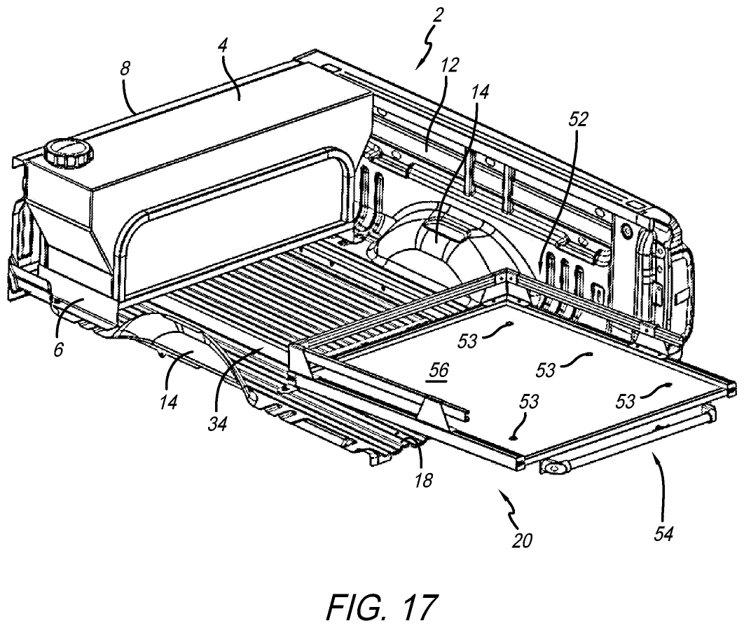

A perspective view of cargo box 2 of FIG. 16 is shown in FIG. 17, including fluid tank 4 seated on fluid tank support frame adjacent bulkhead 8. This view, similar to FIG. 2 of the prior embodiment, shows short bedslide 54 and deck 56 extending from tailgate end 20 of cargo box 2. This embodiment demonstrates modularity of bedslide assemblies. This is because lower frame 34 may be the same for a standard-sized bedslide, short offset bedslide assembly 16, and short bedslide assembly 52. It is only the bedslide portion and upper rail that are switched out to accommodate the different bedslide types.

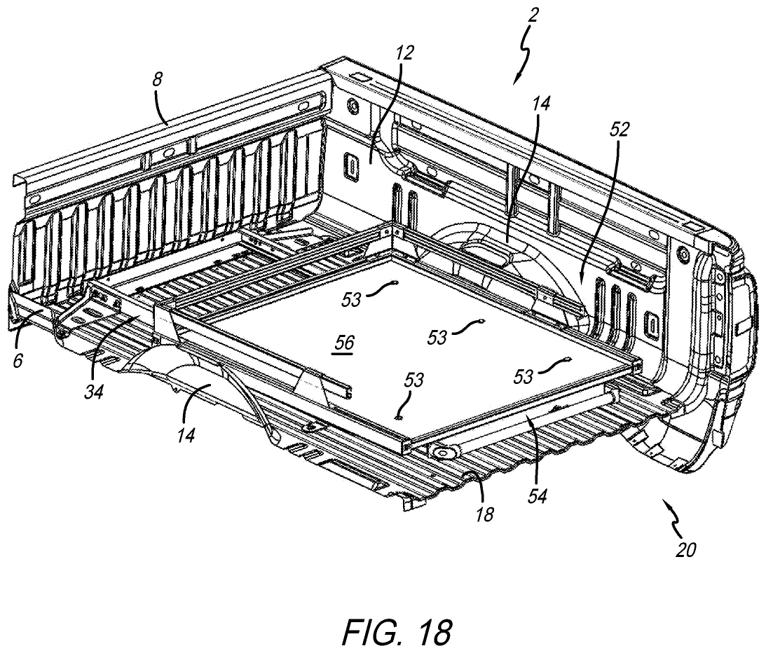

A perspective view of cargo box 2 showing short bedslide assembly 52 attached to cargo box floor 18, with the fluid tank and fluid tank support frame removed, is shown in FIG. 18. This view helps demonstrate how short bedslide assembly 52, despite being coupled to a full-size lower frame 34, retracts back only a partial way on same.

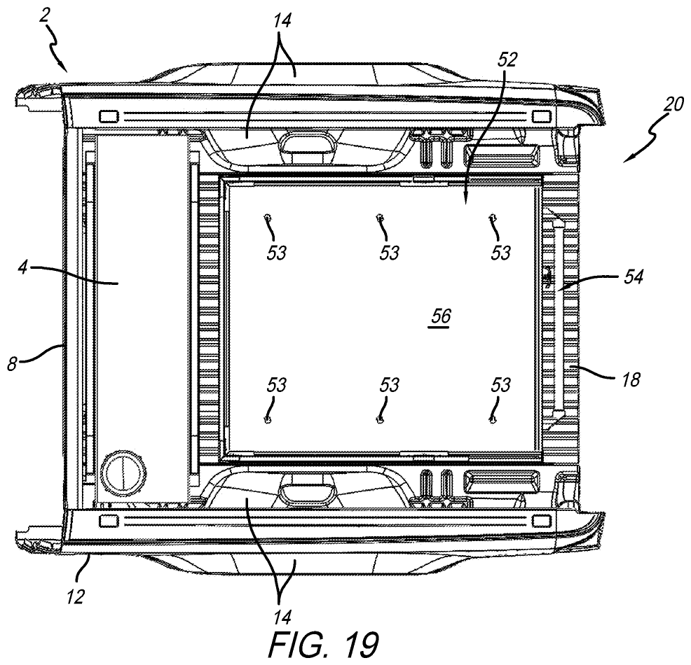

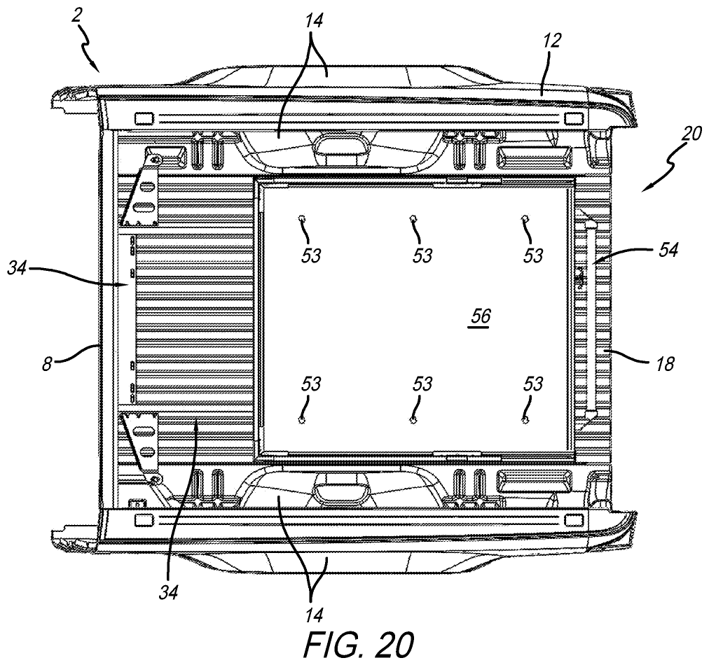

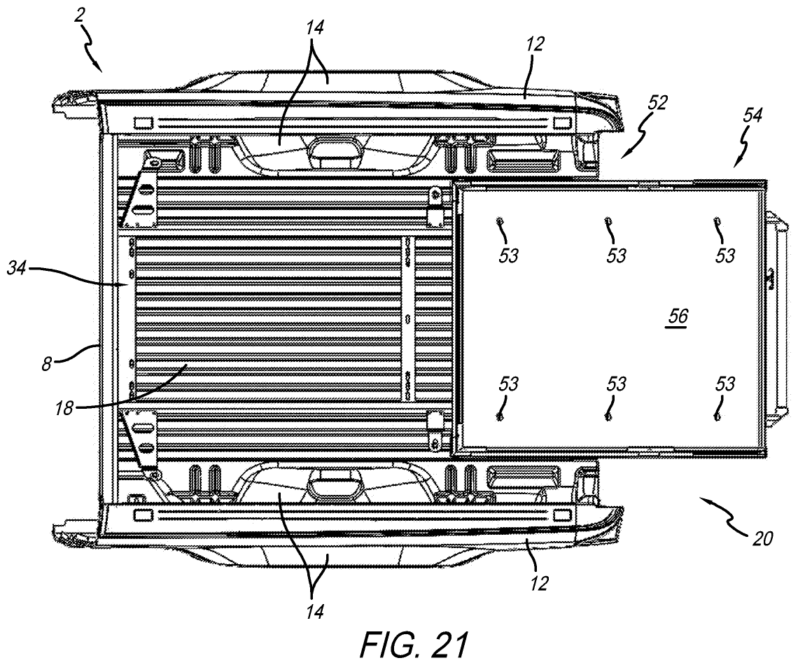

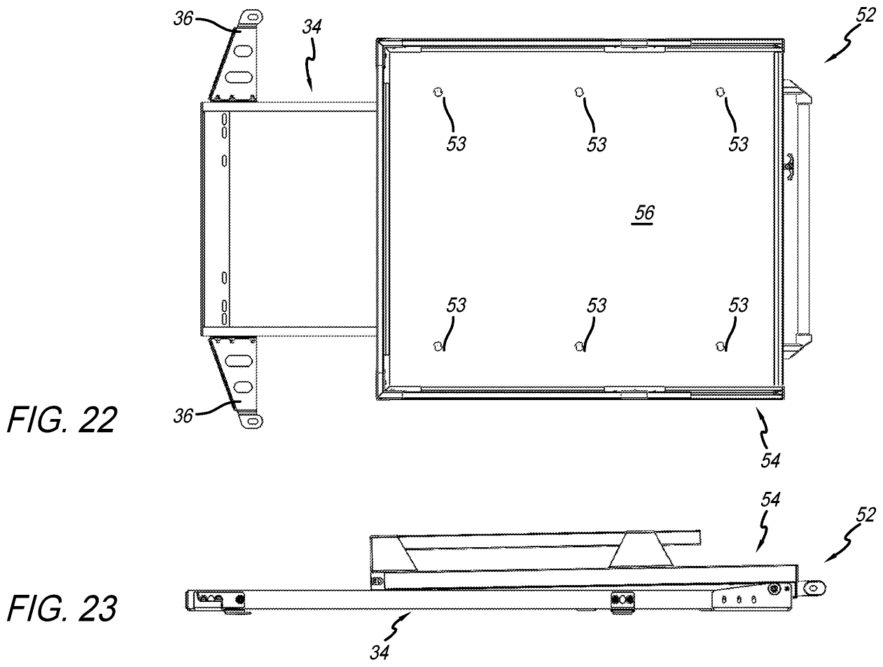

Top views of the cargo box with short bedslide assembly 52 located thereon are shown in FIGS. 19, 20, and 21. These views depict the general area of real estate on cargo box floor 18 that the short bedslide assembly 52 occupies. The views shown in FIGS. 19 and 20 depict short bedslide assembly 52 retracted into cargo box 2, with fluid tank 4 located adjacent bulkhead 8, in FIG. 19, and removed in FIG. 20. The view in FIG. 21 shows short bedslide 54 and deck 56 extended from tailgate end 20 of cargo box 2. Isolated top and side elevational views of short bedslide assembly 52 are shown in FIGS. 22 and 23.

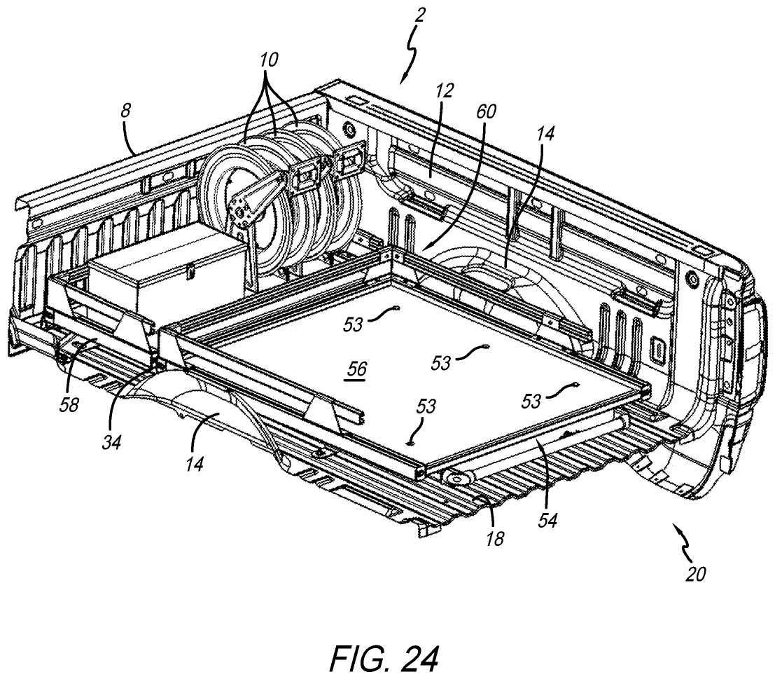

For applications where a short bedslide assembly 52 or short offset bedslide assembly 16 has utility along with accessories storage adjacent bulkhead 8 and/or sidewall 12, but not specifically attached to cargo box 2, a fixed deck 58 can be attached to lower frame 34 to accommodate those accessories. Thus, another illustrative embodiment of the present disclosure provides a dual deck bedslide assembly 60. A perspective view of cargo box 2, in FIG. 24, shows a short bedslide 54 and deck 56 located adjacent a fixed deck 58 which itself is located adjacent bulkhead 8. Here, however, there is no fluid tank 4 or other like structure attached to cargo box 2. Instead, fixed deck 58 occupies the forward portion of cargo box 2 adjacent bulkhead 8. Fixed deck 58 has a deck surface or platform that does not move with bedslide 54.

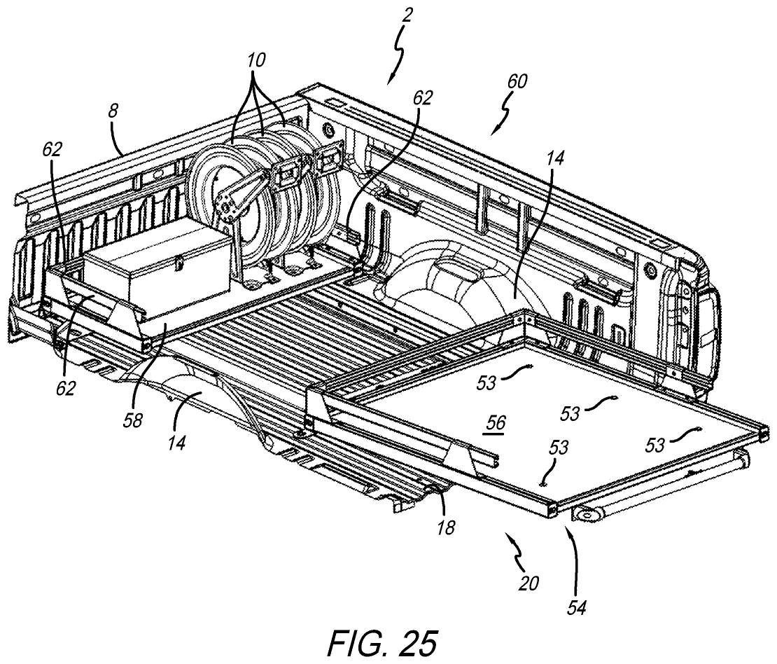

Accessories may be placed on fixed deck 58, as needed, independent of other accessories that need to be pulled from cargo box 2, via the bedslide 54. This is illustratively shown in FIG. 25. Here, a perspective view of cargo box 2 is shown with bedslide 54 extended from tailgate end 20 of cargo box 2. Bedslide 54 moves along lower frame 34 while fixed deck 58 remains stationary adjacent bulkhead 8. It is appreciated that optional railings 62 may be placed about the periphery of fixed deck 58 (as well as bedslide deck 56) as shown. It is also appreciated that fixed deck 58 may be used in conjunction with short offset bedslide assembly 16, alternative to short bedslide assembly 52 shown here.

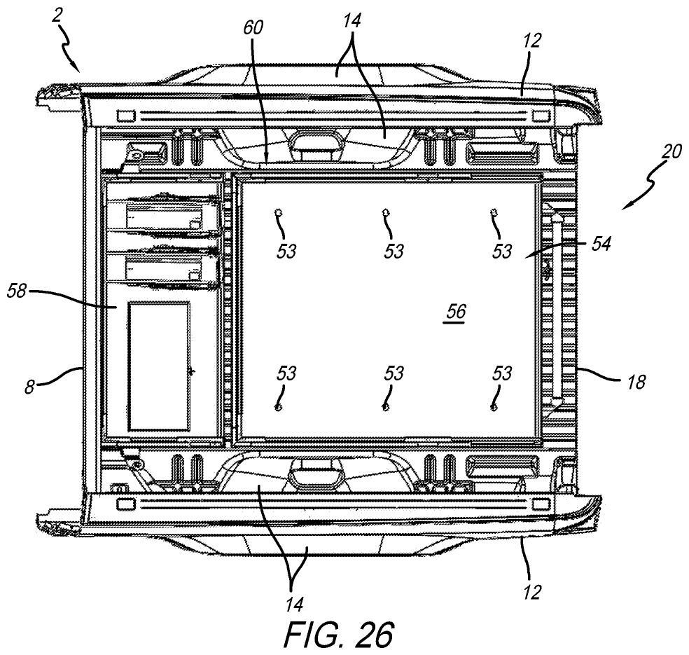

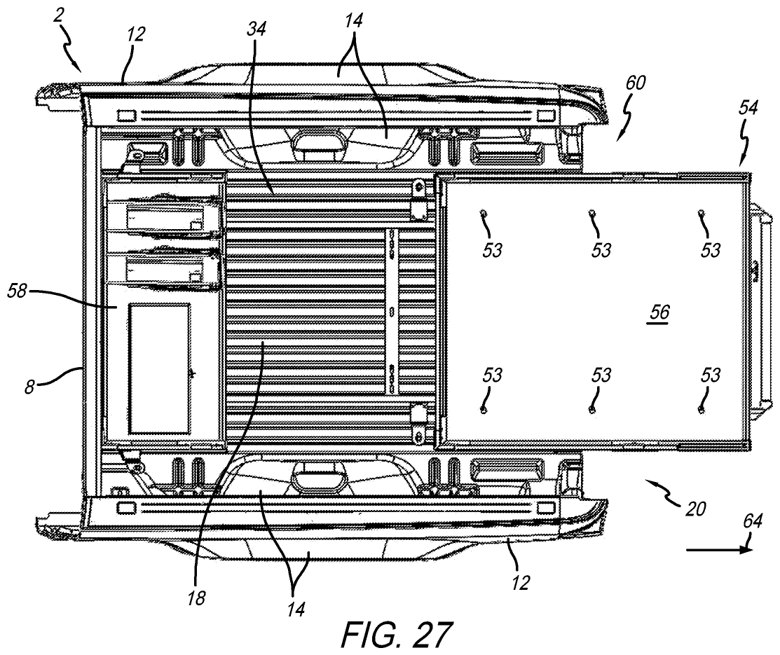

Top views of cargo box 2 showing the dual deck bedslide assembly 60, similar to that of the perspective views of FIGS. 24 and 25, are shown in FIGS. 26 and 27, respectively. The view in FIG. 26 shows dual deck bedslide assembly 60 in the retracted position over cargo box floor 18 of cargo box 2. Fixed deck 58 is shown located adjacent bulkhead 8. The top view in FIG. 27 shows short bedslide 54 extended from tailgate end 20 in direction 64. Again, in the illustrated embodiment, bedslide 54 may be the same as the short bedslide 54 shown in FIGS. 16 through 23. It is also appreciated that, alternatively, short bedslide 54 may be replaced with short offset bedslide 16 if needs for cargo box 2 so dictate.

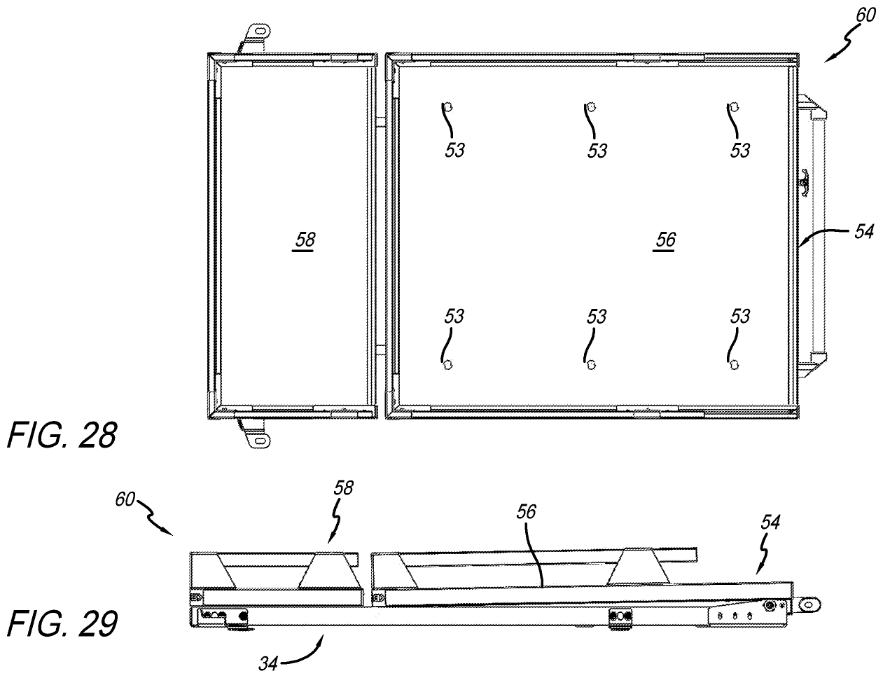

Isolated top and side views of the dual deck bedslide assembly 60 are shown in FIGS. 28 and 29. These views depict the relative positioning of short bedslide 54 and bedslide deck 56 with fixed deck 58. It is appreciated how this dual deck configuration provides substantial coverage over cargo box floor 18 of cargo box 2 (see, also, FIG. 26). As shown in the side view, short bedslide 54 is movable along lower frame 34, whereas fixed deck 58 can be attached to the rear of lower frame 34.

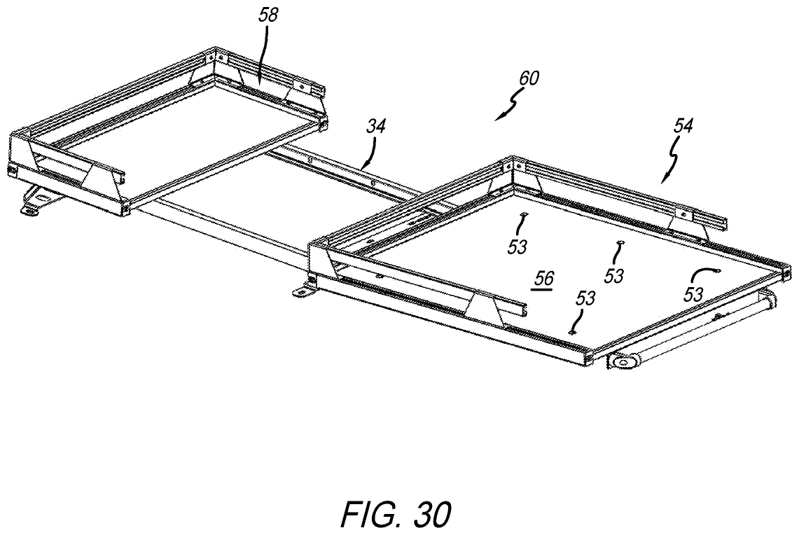

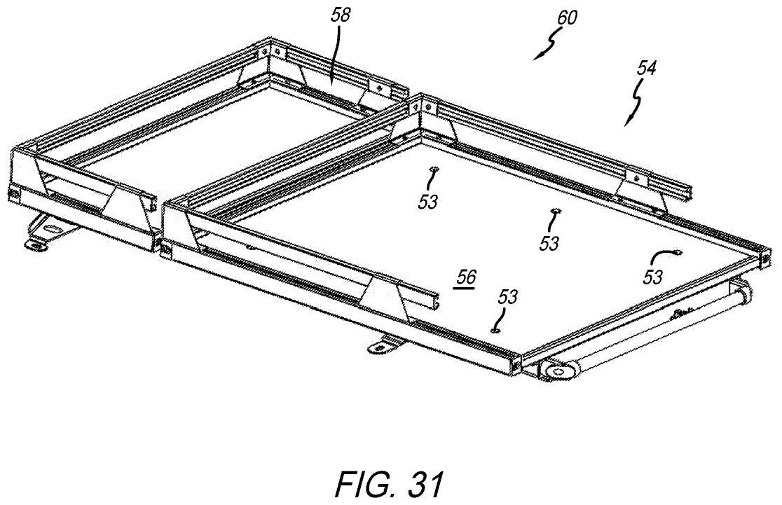

Isolated perspective views of the dual deck bedslide assembly 60 are shown in FIGS. 30 and 31. The difference in these views is that short bedslide 54 is retracted in FIG. 30 and extended in FIG. 31, with respect to lower frame 35.

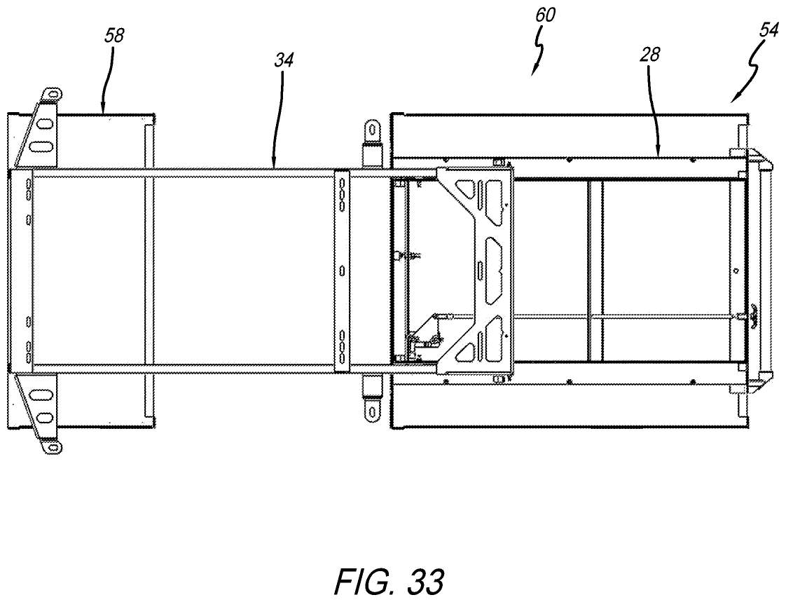

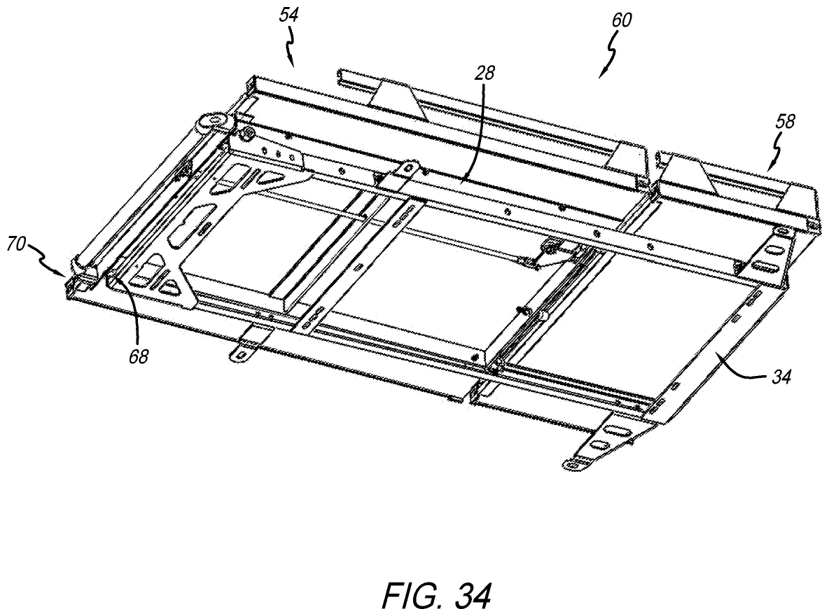

Isolated underside views of dual deck bedslide assembly 60 are shown in FIGS. 32 and 33. These views depict upper and lower frames, 28 and 34, respectively, similar to that of short offset bedslide assembly 16. Here, however, short bedslide 54 is not cantilevered to one side more than the other side. In contrast, short offset bedslide 22 may replace the bedslide shown herein if desired needs for use of cargo box 2 so dictate. Fixed deck 58 is attachable to lower frame 34 rearward of bedslide deck 56. The views in FIGS. 32 and 33 differ in that short bedslide 54 is in its fully retracted position with respect to lower frame 34 in FIG. 32, whereas it is extended at least partially from lower frame 34 in FIG. 33. This view shows how fixed deck 58 remains stationary with respect to lower frame 34, as the short bedslide 54 is movable to and from same.

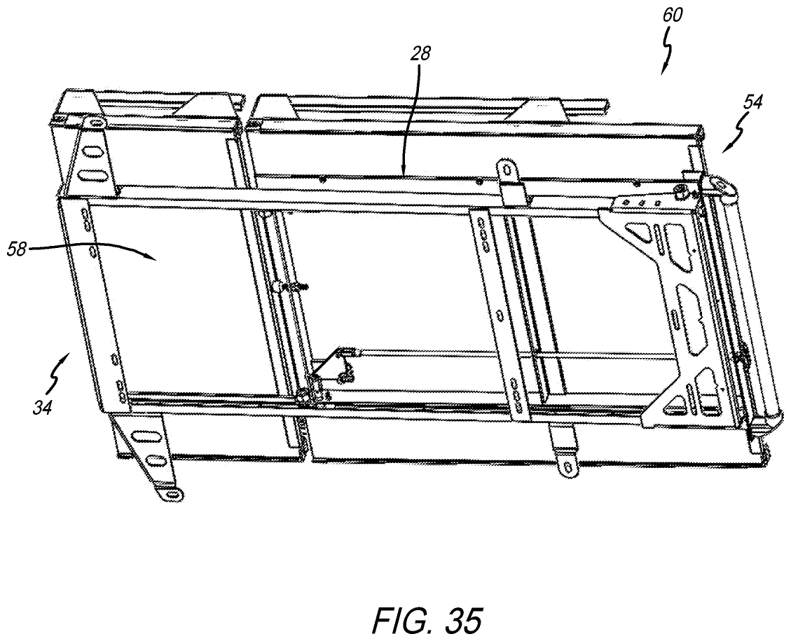

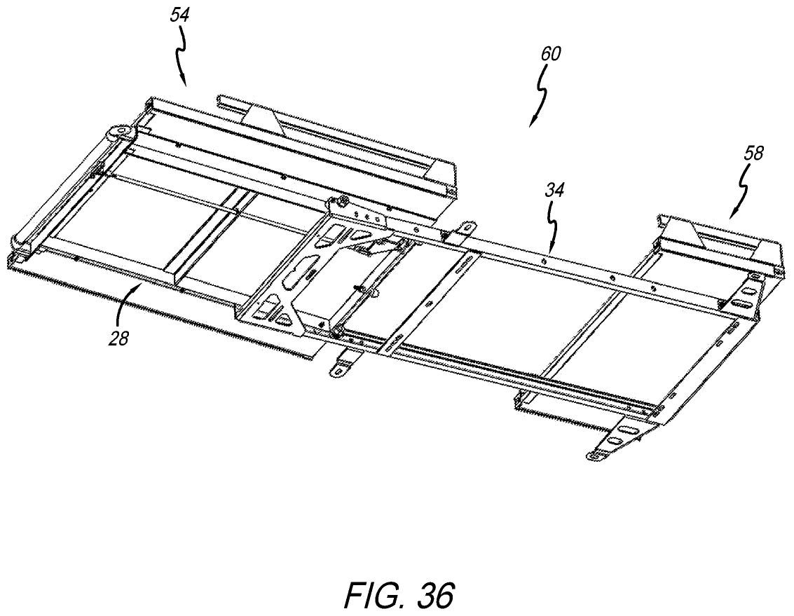

Isolated underside, isolated reverse underside, and isolated underside extended views of the dual deck bedslide assembly 60 are shown in FIGS. 33, 35, and 36. These views demonstrate how fixed deck 58 is positioned on lower frame 34 relative to short bedslide 54 which is movable relative thereto. Additionally, as with all of short bedslide and short offset bedslide assemblies 16 and 52, respectively, the extent to which they are able to retract into cargo box 2 may be limited by the front end 70 of bedslide 54 engaging front end 68 of lower frame 34. It is appreciated that, additionally, or in the alternative, the end of travel of short bedslide 54 over lower frame 34 may be dictated by the stop mechanism that engages receiving holes in the rail of the lower frame.

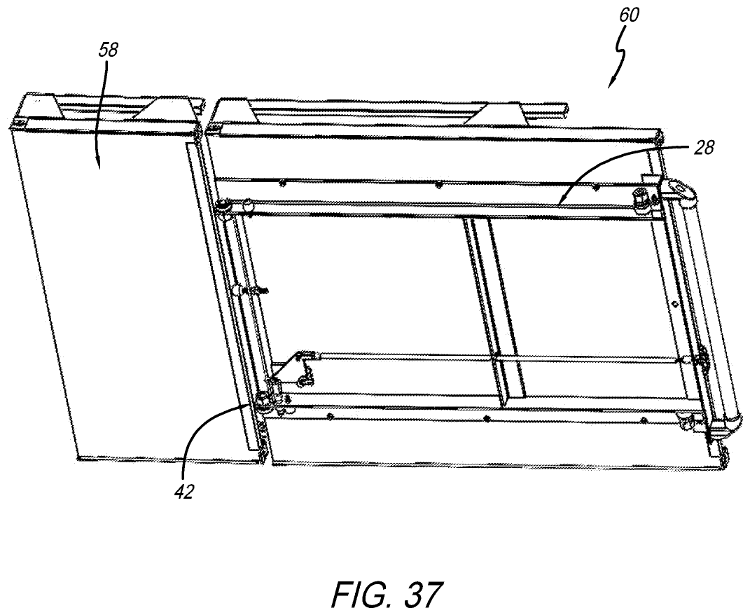

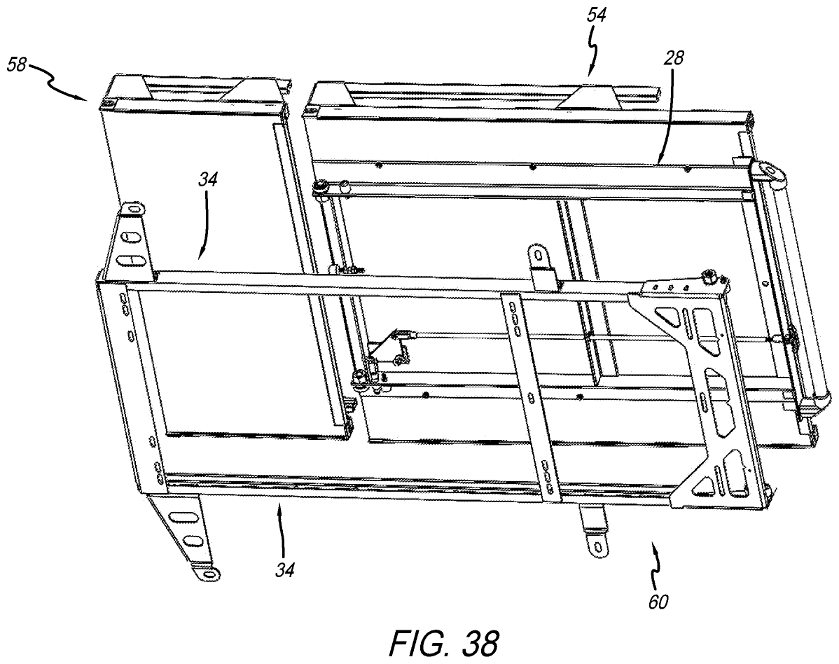

Isolated perspective underside views of the short bedslide 54 and fixed deck 58, as well as an exploded view of short bedslide 54, fixed deck 58, and lower frame 34 are shown in FIGS. 37 and 38, respectively.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that, to the extent any subject matter disclosed in this non-provisional patent document conflicts with the priority application, the disclosure from this non-provisional patent document controls.

What is claimed:

1. A bedslide assembly comprising:
a bottom frame that includes at least one rail;
a top frame that includes at least one rail;
a deck attached to the top frame;
wherein the at least one rail of the bottom frame engages the at least one rail of the top frame;
wherein the at least one rail of the top frame is slidable along the at least one rail of the bottom frame;
wherein the at least one rail of the top frame is extendable from the at least one rail of the bottom frame;
wherein the at least one rail of the bottom frame is longer than the at least one rail of the top frame;
wherein the at least one rail of the top frame does not retract to a rear portion of the bottom frame;
wherein the top frame and the deck extend outward from the bottom frame, but do not retract over an entirety of the bottom frame; and
wherein the deck is positioned offset from the top frame such that a first side of the deck is positioned further from a first side of the top frame than a second side of the deck is positioned from a second side of the top frame.

2. The bedslide assembly of claim 1, wherein a portion of the at least one rail of the bottom frame is exposed from the deck when the deck and the top frame are fully retracted.

3. The bedslide assembly of claim 1, further comprising a static deck that is attachable to the rear portion of the bottom frame.

4. The bedslide assembly of claim 1, further comprising a second deck located on the bedslide assembly, wherein the deck and the top frame are movable with respect to the bottom frame and the second deck.

5. The bedslide assembly of claim 4, wherein the second deck is movable with respect to the deck.

6. The bedslide assembly of claim 3, wherein the deck and the top frame are movable with respect to the bottom frame and the static deck.

7. The bedslide assembly of claim 1, wherein the deck is selectively removable and replaceable with a plurality of different sized decks attachable to the top frame.

8. A bedslide assembly comprising:
a bottom frame that includes at least one rail;
a top frame that includes at least one rail;
a deck attached to the top frame;
wherein the at least one rail of the bottom frame engages the at least one rail of the top frame;
wherein the at least one rail of the top frame is slidable along the at least one rail of the bottom frame;
wherein the at least one rail of the top frame is extendable from the at least one rail of the bottom frame;
wherein the at least one rail of the bottom frame is longer than the at least one rail of the top frame;
wherein the at least one rail of the top frame does not retract to a rear portion of the bottom frame; and
wherein the top frame and the deck extend outward from the bottom frame, but do not retract over an entirety of the bottom frame.

9. The bedslide assembly of claim 8, wherein the deck is positioned offset from the top frame such that a first side of the deck is positioned further from a first side of the top frame than a second side of the deck is positioned from a second side of the top frame.

10. The bedslide assembly of claim 8, wherein a portion of the at least one rail of the bottom frame is exposed from the deck when the deck and the top frame are fully retracted.

11. The bedslide assembly of claim 8, further comprising a static deck that is attachable to the rear portion of the bottom frame.

12. The bedslide assembly of claim 8, further comprising a second deck located on the bedslide assembly, wherein the deck and the top frame are movable with respect to the bottom frame and the second deck.

13. The bedslide assembly of claim 12, wherein the second deck is movable with respect to the deck.

14. The bedslide assembly of claim 11, wherein the deck and the top frame are movable with respect to the bottom frame and the static deck.

15. The bedslide assembly of claim 8, wherein the deck is selectively removable and replaceable with a plurality of different sized decks attachable to the top frame.

16. A bedslide assembly comprising:
a bottom frame that includes at least one rail;
a top frame that includes at least one rail;
a deck attached to the top frame;
wherein the at least one rail of the bottom frame engages the at least one rail of the top frame;
wherein the at least one rail of the top frame is slidable along the at least one rail of the bottom frame;
wherein the at least one rail of the top frame is extendable from the at least one rail of the bottom frame; and
wherein the at least one rail of the bottom frame is longer than the at least one rail of the top frame.

17. The bedslide assembly of claim 16, wherein the at least one rail of the top frame does not retract to a rear portion of the bottom frame.

18. The bedslide assembly of claim 16, wherein the top frame and the deck extend outward from the bottom frame, but do not retract over an entirety of the bottom frame.

19. The bedslide assembly of claim 16, wherein the deck is positioned offset from the top frame such that a first side of the deck is positioned further from a first side of the top frame than a second side of the deck is positioned from a second side of the top frame.
